(19) United States
(12) Patent Application Publication
(10) Pub. No.: US 2016/0277933 A1
(43) Pub. Date: Sep. 22, 2016

(54) Secure Data Communication system between IoT smart devices and a Network gateway under Internet of Thing environment

(71) Applicant: Jongsub Moon, Glenview, CA (US)

(72) Inventor: Jongsub Moon, Glenview, CA (US)

(21) Appl. No.: 15/072,385

(22) Filed: Mar. 17, 2016

(30) Foreign Application Priority Data
Mar. 18, 2015 (KR) 10-2015-0037278

(51) Int. Cl. H04W 12/10; H04L 29/06; H04W 12/04

(52) U.S. Cl. CPC H04W 12/10; H04W 12/04; H04L 63/0492

(57) ABSTRACT

It is secure to send/receive data with encrypted in IoT circumstance.

This invention disclosure describes protocols that guarantees a secure communication and even, secure decoding even inside a network gateway. The main concept includes how to generate the seed used for generating a session key. To do this, description of the structure of a network gateway in which an embedded secure element (hardware chip for security functions) and the eSE is circuited to the processor installed in the network gateway is given. Under the structure, both the smart sensor and the eSE share the same seed. To have the same seed, they have the same time information and the ID stored in the eSE. To enhance the security level, an instant random number can be used instead of a fixed ID. With the same seed, two parties generates the same session key. Finally, the decoding process is performed inside the eSE. So, decoding process is very secure without revealing the decoding key.

### TECHNICAL FIELD

The invention is a technique related to the security in the communication between a wireless smart device and a network gateway or server (hereinafter, a network gateway) connected with Internet. In other words, this is security communication system between a wireless smart device and a network gateway in order to provide security in wireless communication.

### BACKGROUND OF THE INVENTION

Pre-existing techniques that are relevant to the invention are stream encryption and decryption techniques. These are well described in below references.
[Reference 1] Stream Cipher http://en.wikipedia.org/w/index.php?title=Stream_cipher&oldid=643694071
[Reference 2] Embedded Multimedia Controller (eMMc):
   http://www.samsung.com/global/business/semiconductor/product/flash-emmc/overview
[Reference 3] Hash Chain http://en.wikipedia.org/w/index.php?title=Hash_chain&oldid=642451404
[Reference 4] One time Password http://en.wikipedia.org/w/index.php?title=One-time_password&oldid=639661431
[Reference 5] Advanced Encryption Standard (AES) http://en.wikipedia.org/w/index.php?title=Advanced_Encryption_Standard&oldid=6465315
[Reference 6] Elliptic curve cryptography (256 bit ECC-3072 RSA) http://en.wikipedia.org/w/index.php?title=Elliptic_curve_cryptography&oldid=646542169
[Reference 7] Digital Signature Algorithm http://en.wikipedia.org/w/index.php?title=Digital_Signature_Algorithm&oldid=644885167

### SUMMARY OF INVENTION

### Technical Problem

Various sensors used in the Internet of Thing (IoT) can transmit data on wire or wireless systems via microprocessor inside. So, these sensors are called the smart sensors or the IoT Controllers. The microprocessors are ranged from the simplest one (for example, passive RFID) without using a power to powerful CPU equipped with plurality of cores (for example, quad-core).

Because the data which the smart sensor transmits is non-encrypted plain text, the content of it is easily identified externally.

Therefore, in this environment, the malware code can easily sniff or spoof data stored in a network gateway for gathering and processing the data. Even though the smart sensor network transmits an encrypted data to the gateway, eventually the malware code gets to know the decrypting key because the key is inside the gateway.

This invention disclosure provides a hardware structure and functions under the structure, which provide secure data communication between a smart sensor and a network gateway, and more the encrypted data is securely decrypted without disclosing encoding/decoding key.

### Solution to Problem

The smart sensor encrypts a data by Stream cipher method or by a well known encryption method (for example, AES) and, optionally adds a digital signature to verify the integrity of the data and then, send the data to a network gateway.

The session key used for encryption/decryption is generated based on a seed value. The seed value is a combination of a time information and an unique identification number (ID) which is securely stored inside the Embedded Security Element (eSE, a security module). Also, the eSE which is embedded in the network gateway also uses the same information for generating the same seed as the smart sensor.

Thus, both parties use the same seed. So, if both parties have the same algorithm to generating session key with the same seed, the session keys for encrypting and decrypting are the same.

Also, the application processor in the network gateway does not decrypt the encoded data. The encryption process is performed in the eSE and decrypted data is sent to AP after decrypted inside the eSE. So, even though a malicious code tries to get to the decryption key, it would fail. The code can get only the decrypted data for a limited time.

### Advantageous Effects of Invention

Because collected data in a smart sensor are securely sent to the targeted network gateway and decoded without disclosing the key and, a secured communication channel is provided between a smart sensor and a network gateway of IoT environment, this invention can be applied all IoT field.

### BRIEF DESCRIPTION OF DRAWINGS

FIG. 1 shows the relation between a smart sensor and a network gateway. It also shows the relation between an eSE and application processor inside a network gateway.

FIG. 2 shows the relation between a smart sensor and a network gateway. In contrast to FIG. 1, in this network gateway, an eSE doesn't exist inside a network gateway. In this type gateway, a secure operating system such as SELinux should be operated.

FIG. 3 shows the internal structure of eSE.

FIG. 4 shows the data structure of AP and eSE inside the network gateway.

FIG. 5 shows the protocols among the smart sensor, application processor inside the gateway and eSE of the gateway generating a seed value.

FIG. 6 is the communication sequences (protocols) of the FIG. 5 in time domain.

FIG. 7 is another diagram of the FIG. 1 in which a wireless communication device is connected to eSE directly.

FIG. 8 is another protocol of the FIG. 5 in which a wireless communication device is connected to eSE directly.

FIG. 9 is a protocol for re-generating seed periodically or non-periodically.

FIG. 10 shows the decrypting process in the network gateway for the encrypted data.

FIG. 11 is a authenticating process between an eSE and AP inside a network gateway when downloading an important data (program) for an upgrading.

FIG. 12 shows the relation between AP inside a network gateway and a smart sensor when an eSE doesn't exist.

FIG. 13 shows the protocol to generate a same seed used in AP inside a network gateway and a smart sensor.

FIG. 14 is a protocol for re-generating seed periodically or non-periodically when an eSE doesn't exist.

FIG. 15 shows the decrypting process in the network gateway for the encrypted data when an eSE doesn't exist.

### DESCRIPTION OF EMBODIMENTS

Internet of Thing (IoT) is widely used throughout the world. A smart sensor consists of sensors, wireless communication device and optional processor. It has an internet protocol address (IP address). The sensor receives commands from a server and sends its collected information to the server. This kind of IoT sensor is called a smart sensor. A server computer which collects information coming from smart sensors and sends them to another server, if necessary. This kind of server is called a network gateway hereafter. The function of the network gateway described in this invention disclosure can be combined with a wireless router because the wireless router can function as collecting data in the center of end-point sensor. Followings are two examples of using IoT smart sensor.

### Example 1

A smart sensor consists of a CCTV, a bell, a microphone and a processor. Assume that it is installed inside a house and directed to a front door of the house. This sensor starts to collect CCTV information when a person pushes a door bell or when a noise is detected outdoor. It then sends the collected information to a network gateway in real time. An owner of the house can watch this event taking place on CCTV in his own smartphone in real time.

### Example 2

A smart sensor is attached in a streetlight. The sensor consists of a CCTV, a microphone and a processor. Definitely, the sensor communicates with a serve or an adjacent smart sensor wirelessly. Assume that the sensor can differentiate the screaming sound from the any other noises of the street. Usually the streetlamp is turned off. However, if the sensor catches a screaming sound, it commands to the streetlight to turn on the light and starts to work the CCTV. The moving pictures from the CCTV send to the network gateway to which the sensor is connected.

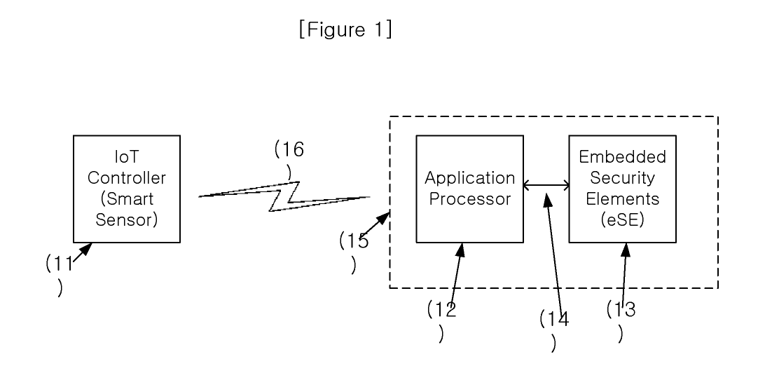

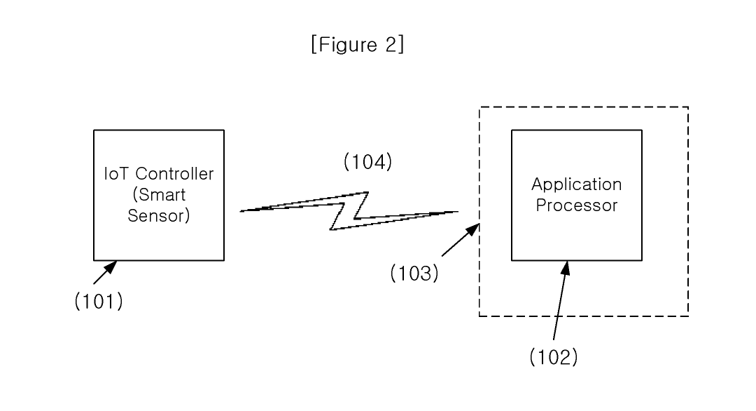

The whole structure of this invention is shown in the both FIGS. 1 and 2. These Figures are relationship between a smart sensor and a network gateway. In FIG. 1, an Embedded Security Element (eSE) is circuited inside the network gateway. The main role of the eSE is to provide the security functions. In contrast to FIG. 1, the eSE is not circuited into the network gateway in FIG. 2. In FIGS. 1 and 2, the smart sensor (11, 101) communicates with the network gateway (15, 103) wirelessly (16, 104). Also, there can be a wireless access point. The wireless access point collects information from the smart sensor(s) and then sends the information through wired communication line. The communication methods are not limited to the wireless only. It can use with any kind of communication.

A configuration of the network gateway is described in FIGS. 1 and 2. So, it has a general purpose CPU or application processor (hereafter, AP). In FIG. 1, the AP is connected to the eSE with signal bus-line. The communication in the bus-line is protected from the outside with a secure channel like SCP11. To make more secure between the AP and the eSE, the AP and the eSE can be packed within a hardware chip (15).

The function of the gateway may sends/receives the information from a smart sensor to the other network gateway (including a server) or a client like a mobile-phone. Also, the network gateway stores the data to the gateway's storage and provides many kind of security functions to the network gateway. The security functions are, for example, encryption/decryption and authentication between a smart sensor and the network gateway.

FIG. 2 is a structure of the network gateway in which the eSE is not circuited. To provide secure functions, the hardware should have a environment like Trusted Execute Environment (TEE) of ARM. And also, the operating system has secure environment like SELinux under the TEE. That is, security functions such as encryption/decryption, hiding session keys and secure access control should be protected by operating system. In this Figure, the smart sensor (101) exchanges (104) data with the network gateway (103) wirelessly and the processing including security functions are executed by only AP (102) inside the network gateway. The network gateway equips the security algorithm and its unique ID. The algorithms are installed in firmware and the algorithms are checking for integrity during booting time. So, the algorithm doesn't have any risk to be hacked.

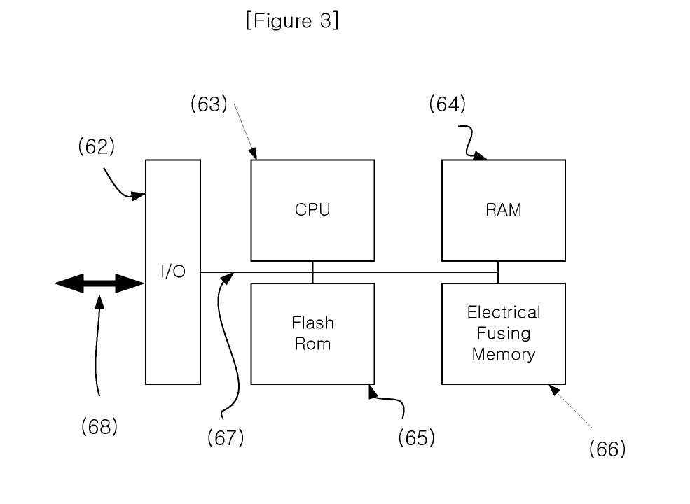

FIG. 3 shows the conceptual structure inside the eSE. All elements in eSE are circuited within one hardware chip. So, the eSE is very secured like smartcard. This looks like a small computer which has core (63), RAM (64), ROM (65), and a memory (66) which were fused physically. So, if a person try to analyze the memory (66), the memory is broken.

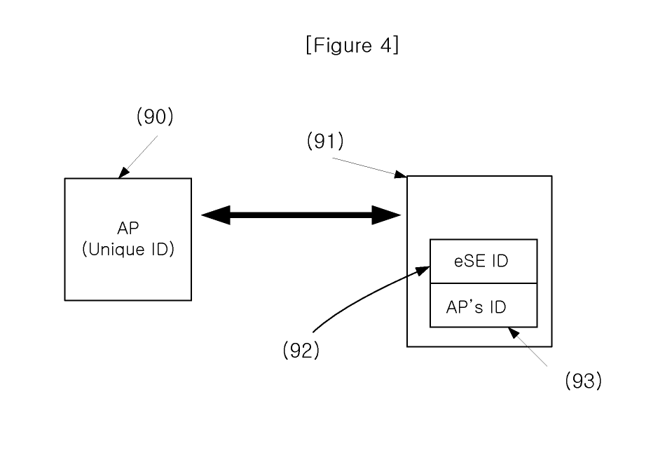

The eSE and AP has its own unique ID number. The numbers are generated fully randomly. The eSE stores optionally the AP's ID also as well as its own ID. Because these IDs are fused physically, nobody can read the ID data with any method (92 of FIG. 4). The security algorithms like encryption/decryption, one time password, and authentication are stored in ROM (65) as well as other additional programs.

The eSE communicates with other external hardware chips like AP via I/O routines (62). For example, if a encoded data inputs from AP through I/O (62) wirelessly (68), the eSE decodes the data and then resends the decoded data wirelessly (68). Because the decryption process is done inside eSE, there is no method to know the key for decryption. In case of FIG. 2, the operating system hide the key with the help of ARM CPU, and no one can get the key.

The encryption/decryption algorithms used in this eSE (or network gateway) and smart sensor are symmetric algorithms which were well known as secure. In this patent, that can be Advanced Encryption Standard (AES) for block data or Stream Cipher for stream data.

The data structure for IDs in the eSE and the AP is shown in FIG. 4. Both CPU (or AP) has its own unique ID (90). The eSE has also the AP's ID as well as its own ID. In case of FIG. 2, the AP has its own ID. The eSE and the AP may contain the digital signature (hash value) of their own IDs in order to validate whether IDs are changed or not. The IDs and/or the hash values can be stored with encoded form. If saved with encoded, they should be decoded before using. The key for encoding/decoding for IDs and hash value is saved inside the fusing memory.

For detail description of this patent, two cases; the case are described; the case where eSE is installed in the network gateway and the case where the eSE is not installed.

(The Case where an eSE is Installed with AP in a Network Gateway)

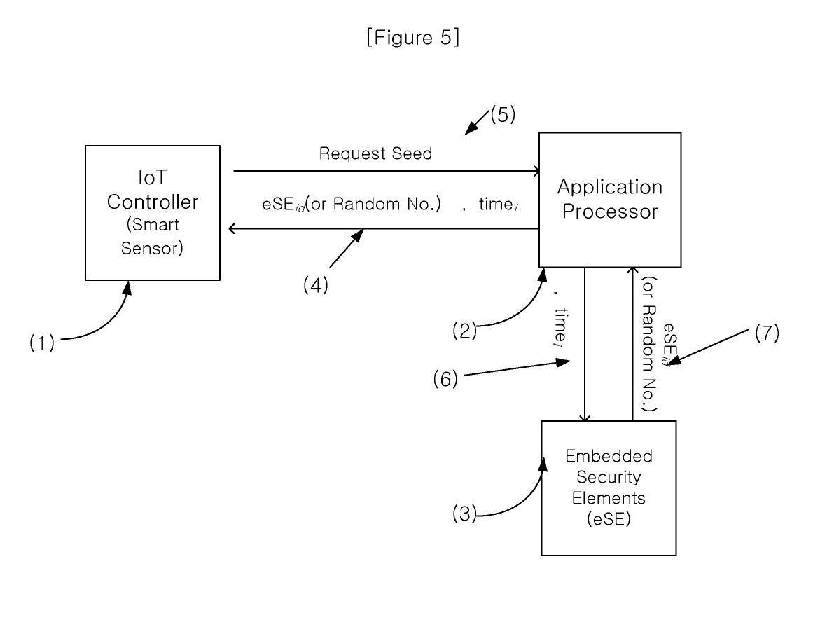

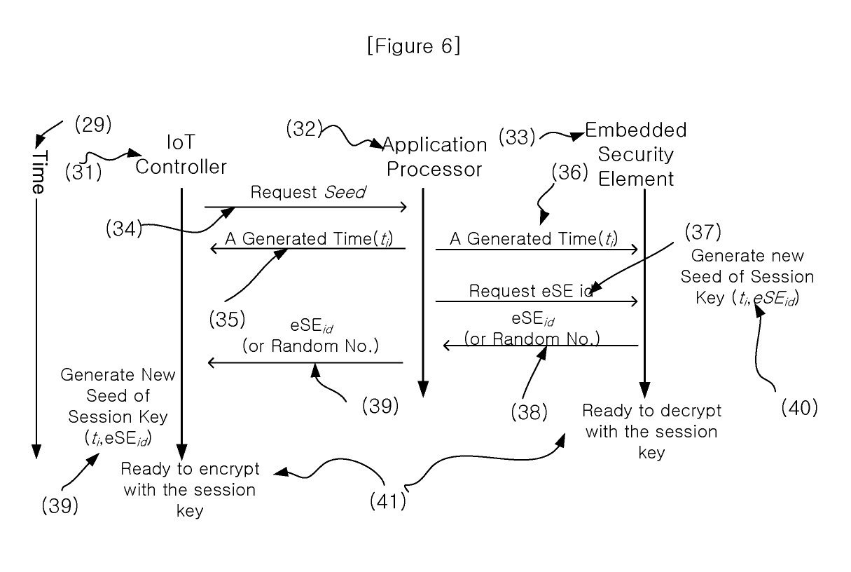

FIGS. 5 and 6 explains how the initial seeds for generating a session key are matched in a smart sensor (1) with the corresponding eSE (3) in the network gateway. FIG. 5 is a schematic diagram and FIG. 6 is the protocols between the smart sensor and the eSE. Because they use a symmetric encoding/decoding algorithm, the session key for this work should be same. So, to make a same session key, the seed for generating the session key should be same, especially for OTP. The seed for both the eSE and the smart sensor is a combination of unique ID of eSE and time information generated promptly. Instead of eSE's ID, a random number may be used. That is, to generate a session key, function (a random number, a time information) or function (a ID of eSE, a time information) is the seed, where function means a mathematical function. At this invention disclosure, the ID means either the unique ID of eSE or a random number hereafter.

Referring FIGS. 5 and 6, the sequences for generating a seed for both parties are explained.

First, the smart sensor (1, 31) requests (5, 34) a seed to the network gateway (2, 32). The AP (2, 32) generates a time information instantly and sends (35, 36) the time information to both eSE (3, 33) and the smart sensor (1, 31). The eSE sends the ID to the AP (6, 38). At the same time, eSE makes a seed with its ID and the time information delivered (40). The AP (2) sends the time information already generated and the ID from eSE to the smart sensor (4, 39). The smart sensor makes a seed with the ID and the time information transferred from AP. Then, the eSE and the smart sensor use the same algorithm for generating a session key with the same seed.

The algorithm for generating a session key with seed is following.

The length of the session key should be satisfied with the requirement of an encryption/decryption algorithm. For example, if AES algorithm used, the length should be one of 128 bit, 196 bit or 256 bit. The seed may use a part of the combination of (ID, time information) as well as whole combination. If the length of seed is short, a fixed value can be padded.

The algorithm for session key generation is one of following three methods.

(1) The combination of (ID, time information) is a session key itself. For example, the ID followed time information is a session key. Also, the time information followed ID can be a session key.

(2) The combination of (ID, time information) is a seed with random number generator. A random number generator requires an initial seed before being used. The random number generator algorithm should be same in both eSE and smart sensor.

(3) The combination of (ID, time information) is a seed for a one way mathematical function. A mathematical function may be a hash function of OTP. If OTP used, a new session key is generated recursively whenever it is run if a seed is used once. That is, a current session key is used as seed for next session key generating. This can be very safe because the session key can be changed frequently.

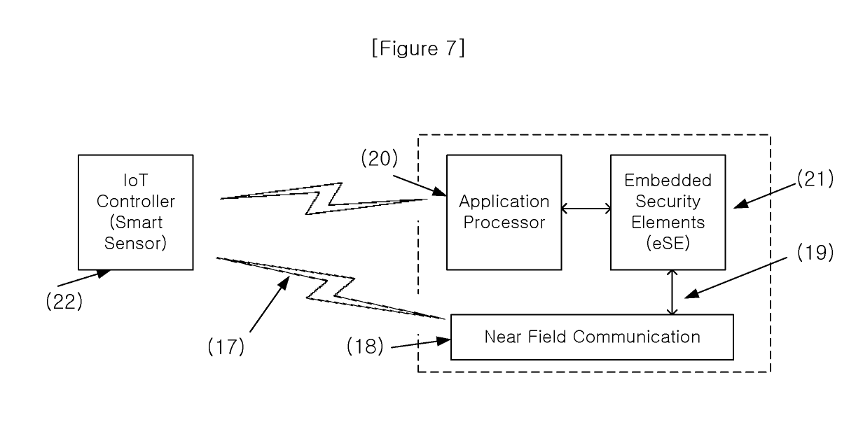

When a communication between a smart sensor and eSE is setup directly via an attached wireless communication device such as Near Field Communication (NFC) or Bluetooth (not via wireless internet), FIG. 7 is used instead of the FIG. 1. In FIG. 7, even if NFC is used for explanation, the device is not limited to NFC only. In this Figure, the eSE (21) sends its own ID to the smart sensor (22) through NFC (18) and not through AP (20).

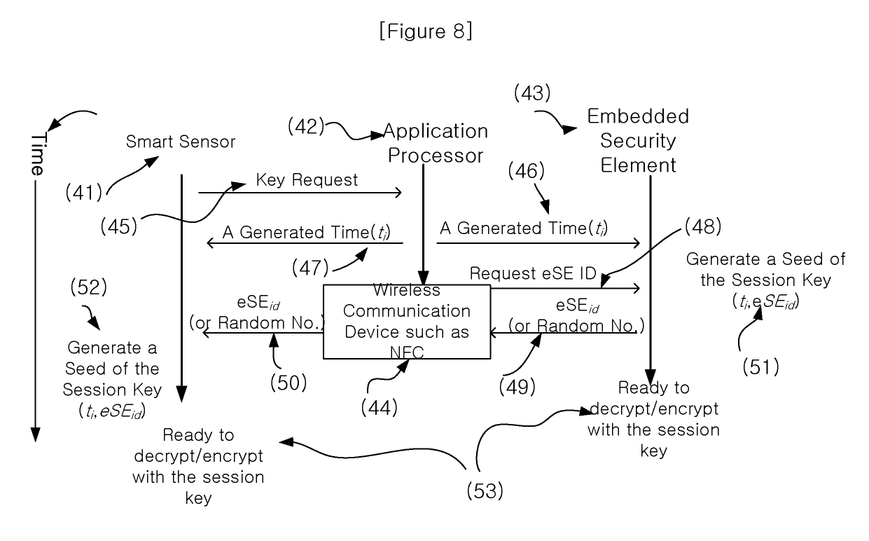

FIG. 8 is the data exchange protocol of FIG. 7 illustrated in time sequence. When the eSE sends its own ID to the smart sensor, it sends to the attached communication device (44) and then the device sends the received ID to the smart sensor in FIG. 8 (50). The remaining parts of FIG. 8 are same as that of FIG. 6.

When wireless communications have occurred between the smart sensor and AP (or communication device) in FIGS. 6 and 8, a message digest or digital signature can be send together also to protecting data modification. With sending the message digest of the message with the message (here, ID), the receiver can

verify the message not being altered.

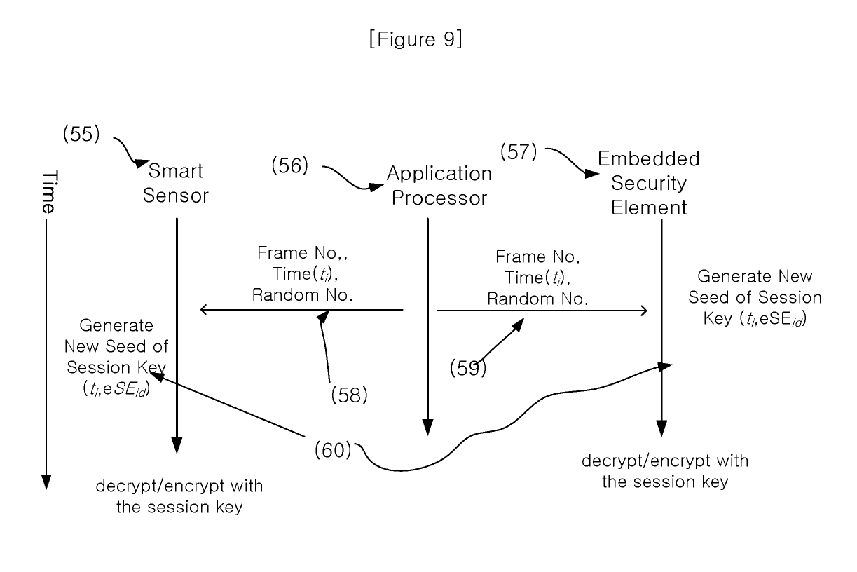

FIG. 9 shows how to generate a session key periodically in order to raise the security level. This is initiated by the AP (56), not by the smart sensor (55). Because the smart sensor and the eSE have the ID already, the AP sends both the new time information and the data frame number in prior to the application of a new session The smart sensor and the eSE makes a new session number when they receives a new time information and the data frame number to be applied. And then, the new session key starts to be applied for encryption/decryption process in the smart sensor and eSE when the data has the matched frame number (60).

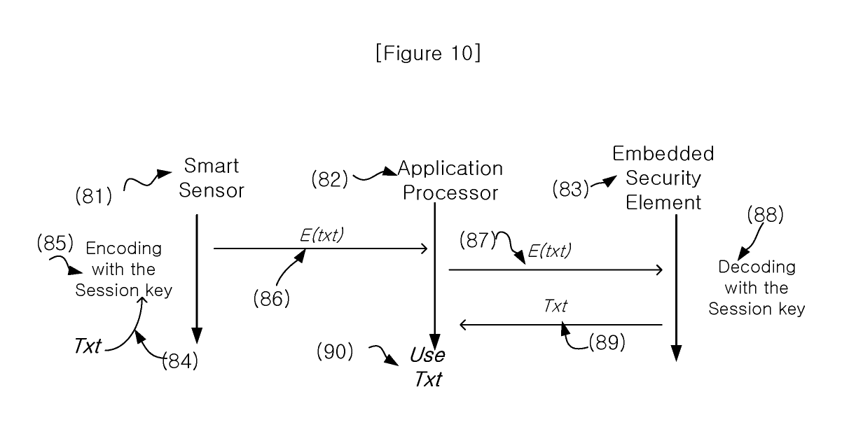

FIG. 10 shows the concept of encryption in the smart sensor and decryption processes in the network gateway. The smart sensor (81) gets a sensed data (84) and then encode it with its session key (85). The smart sensor sends (86) the encrypted data to the network gateway (82). At this time, the message digest of the data can be send also. The AP (82) send (87) the received data to the eSE (83). The eSE decodes the encrypted data with its own session key (88). If the message is accompanied with the data, the eSE checks whether the received data was modified or not during transfer. The plain data which was decoded in eSE is sent to the AP (89).

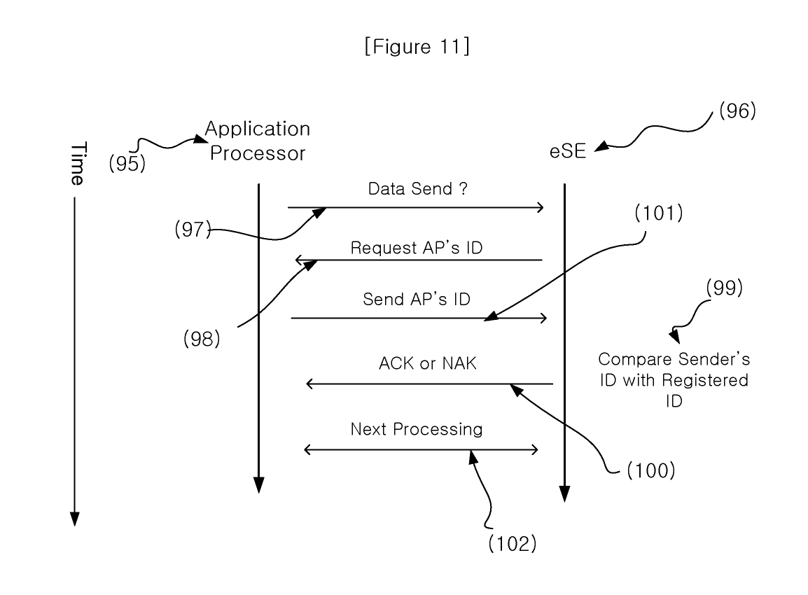

If eSE is packed with AP, the communication between the AP and the-eSE is always secured. However, these two hardware chips are connected with circuit wire and the contents of data between the AP and the eSE can be altered illegally. In this environment, the AP and the eSE may want to authenticate the counterpart before receiving important data from the counterpart. FIG. 11 shows how to authenticate counterpart before receiving important data such as upgrading firmware. If the communication device attached to the eSE exists, this scheme can be applied also. To authenticate each other, the data structure used in each chip uses the same as shown in FIG. 4. The AP has its own ID (90) and the eSE has both its own ID (92) and the AP's ID (93).

The AP (95) in FIG. 11 asks (97) eSE (96) whether to upgrade the firmware of eSE, for example. Then, the eSE asks (98) the AP (95) to send the AP's ID. Then, the AP sends (101) its store ID to the eSE. The eSE compares (99) the received ID and the AP's ID which was stored in eSE. If both IDs are the same, the AP is considered as genuine and then, upgrading process is progressed.

(The Case where an eSE is not Installed with AP in a Network Gateway)

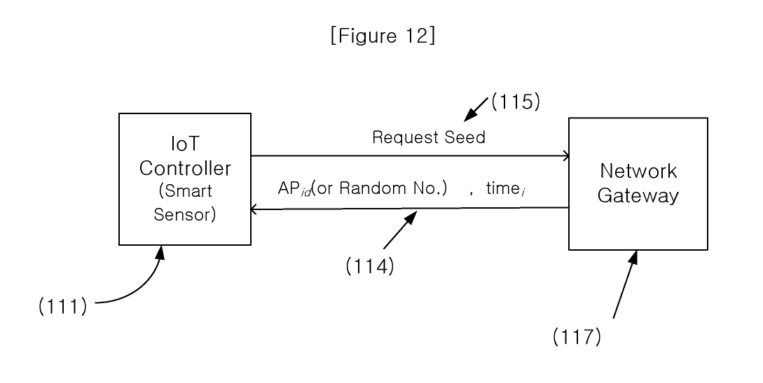

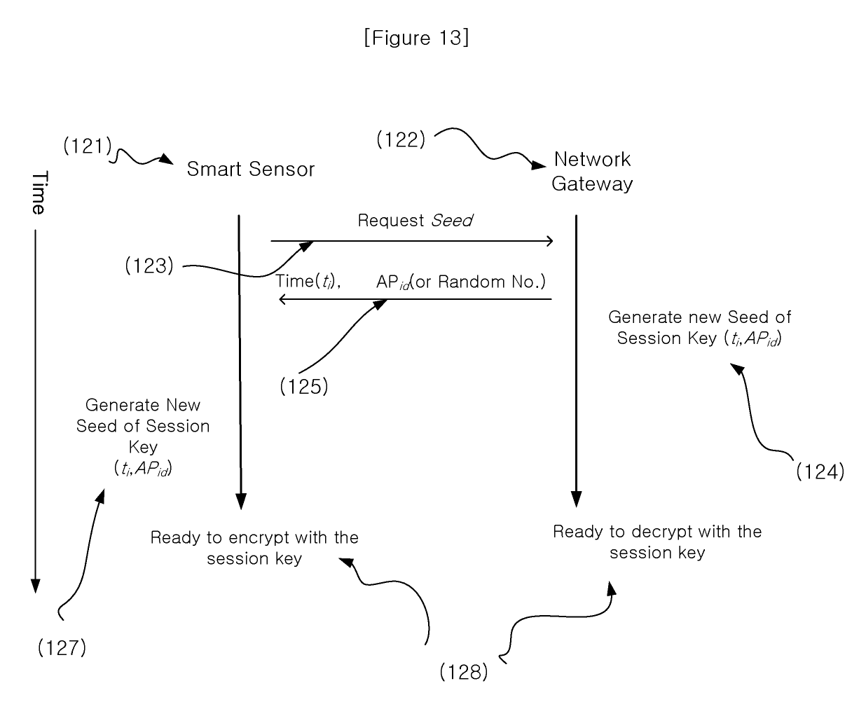

The protocol for making a same seed for both AP and the smart sensor when the eSE is not installed in the gateway is displayed in FIGS. 12 and 13. As described above, a secure operating system such as SELinux was installed in the network gateway. In FIG. 12, a smart sensor asks (115) the network gateway (117) to send information for making a seed. The AP sends (114) its own ID which was store secured and a time information is instantly generated. At the same time, the AP generates its seed with its own ID and the same time information which was sent to the smart sensor. When making the seed, a trusted application program makes the seed and store on a secure storage under the secure operating system. The smart sensor makes the same seed as the network gateway. The algorithm to generate a session key with a seed is already described above. FIG. 13 is a time sequences for protocols described in FIG. 12.

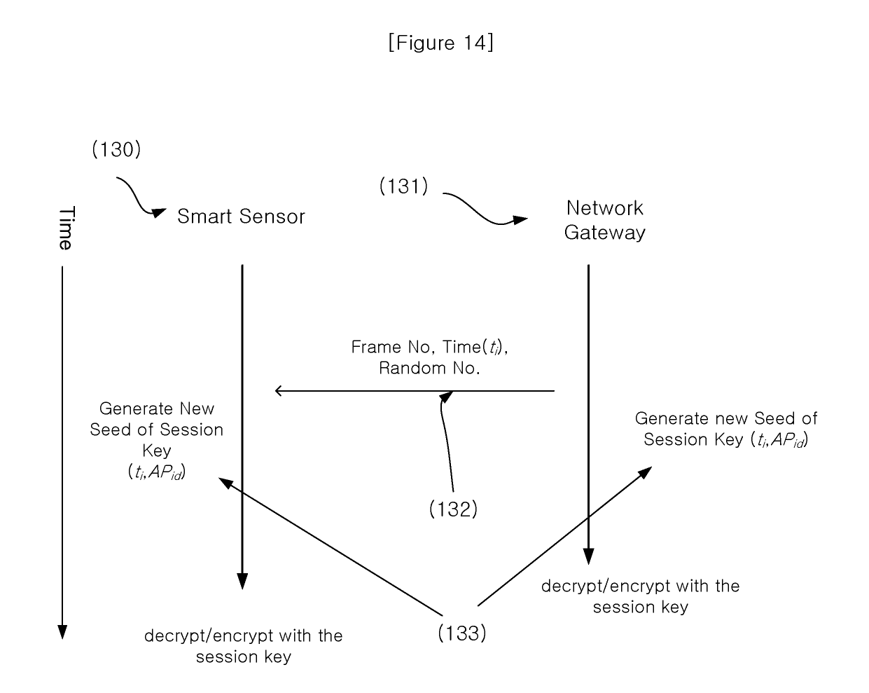

FIG. 14 shows the protocols for generating a seed periodically. Main concept is the same as for the case when eSE exists in the network gateway. The difference is that the AP doesn't have the step to send both time information and data frame number to the eSE. Also, generating algorithm for seed exists in AP and not in eSE. The AP (131) generates a new time information and sends the information with the data frame number to which the new session key generated starts to apply (132). Both the smart sensor (130) and the AP (131) make the same seed value with the same time information and same ID which have been already stored in both the AP and the smart sensor.

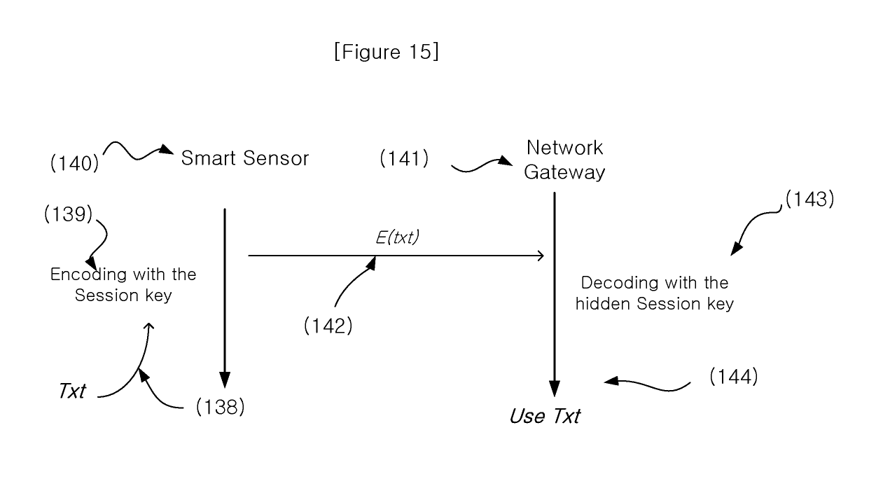

FIG. 15 shows the protocol for the network gateway having decoding data which come from the smart sensor when the eSE doesn't exist. The smart sensor (140) encodes (139) its data (138) with its session key and then sends (142) to the network gateway (141). The network gateway decodes (143) the encoded data with a secured decoding algorithm with the session key stored securely.

### INDUSTRIAL APPLICABILITY

This invention disclosure can be deployed with all IoT system which is constituted with multiple of smart sensors and network gateway (including server) because the methods described in the document provide very secure communication and other security functions.

1. The system for secure data communication between the network gateway and the smart sensor in the IoT field;
The network gateway which consists of a special purpose hardware element called an embedded security element (eSE) and general purpose processor (AP), in which eSE works only for secure functions. The eSE can be packed with AP within one hardware chip or be electrically circuited with the AP;

2. In the claim 1, the eSE which contains a special read only memory (called fusing memory) which are physically fused. In the fusing memory of eSE, many security data can be stored including eSE's unique ID and AP's unique ID. The unique ID means either man made id or a random number generated in the eSE at the time of request. The terminology, ID, is therefore used for following all claims.

3. In the claim 1, the network gateway which contains some communication device such as NFC to which eSE can be connected electronically to.

4. The protocol which provides secure data communication between a smart sensor and a network gateway. The protocol described as follows;
A process in which the smart sensor requests the information to the network gateway;
And then, the process in which the AP asks the ID to the eSE and then the AP receives the ID from the eSE;
And then, the process in which the AP generates a time information promptly;
And, then the process in which the AP send the time information generated with the ID come from the eSE to the smart sensor;
At the same time, the process in which the AP send time information generated to the eSE;
And, then the process in which the session key generation algorithm make a session key with an initial seed in the smart sensor;
At the same time, the process in which the session key generation algorithm make a session key with an initial seed in the eSE;

5. In the claim 4, the combination method for generating a session key. The method a combination of either the ID with the time information or the time information with ID. When the length of the generated seed is less than the required length, the remaining field is filled with a value such as 0.

6. In the claim 4, recursive mathematical function to generate session keys repeatedly without using a seed. The identical session key generating algorithm should be used in both the smart sensor and eSE (or a secure application program in case of not being eSE)

7. In the claim 4, process in which the decoding process is performed inside eSE without revealing the decoding key and then sending the plain text to AP.

8. In the claim 4, the protocols in which session keys are periodically changed; protocols are as follows;
The process in which the AP generates a time information actively.
The process in which the AP sends the time information with a data frame to which is applied to both the smart sensor and the eSE.
The process in which both the smart sensor and eSE make a seed and then make a new session key in advance.
The process in which a new session key is used when the indicated data frame generated.

9. Claim for the protocol which provides secure data communication between a smart sensor and a network gateway. The protocols are described as follows;
A process in which the smart sensor requests the information to the network gateway;
And then, the process in which the AP asks the ID to the eSE;
At same time, the process in which the AP generates a time information promptly;
And then, the process in which the eSE sends the ID to the smart sensor through a communicating device which is electrically circuited to eSE directly.
And, then the process in which the AP sends the time information generated with the ID that come from the eSE to the smart sensor;
At the same time, the process in which the AP sends time information generated to the eSE;
And, then the process in which the session key generation algorithm makes a session key with an initial seed in the smart sensor;
At the same time, the process in which the session key generation algorithm makes a session key with an initial seed in the eSE;

10. In the claim 9, a communicating device which is NFC.

11. In the claim 9 the combination method for generating a session key. The method is the combination of either the ID with the time information or the time information with ID. When the length of the generated seed is less than the required length, the remaining field is filled with a value such as 0.

12. In the claim 9, a recursive mathematical function to generate session keys repeatedly without using a seed. The identical session key generating algorithm should be used in both the smart sensor and eSE (or a secure application program in case of not being eSE)

13. In the claim 9, the process in which the decoding process is performed inside eSE without revealing the decoding key and then sending the plain text to AP.

14. In the claim 9, the protocols in which session keys are periodically changed. The protocols are as follows;
The process in which the AP generates a time information actively.
The process in which the AP sends the time information with a data frame to which is applied to both the smart sensor and the eSE.
The process in which both the smart sensor and the eSE make a seed and then make a new session key in advance.
The process in which a new session key is used when the indicated data frame generated in which both the smart sensor and the network gateway.
